(19) United States
(12) Patent Application Publication
(10) Pub. No.: US 2012/0235451 A1
(43) Pub. Date: Sep. 20, 2012

(54) Seat Cargo Spacer

(76) Inventor: Martin Hrdlicka, Montgomery, IL (US)

(21) Appl. No.: 13/419,814

(22) Filed: Mar. 14, 2012

Related U.S. Application Data
(60) Provisional application No. 61/452,834, filed on Mar. 15, 2011.

(51) Int. Cl. B60N 2/44

(52) U.S. Cl. 297/188.2; 297/188.01

(57) ABSTRACT

A car seat storage providing an area of space for storage of loose items within a vehicle. The car seat storage system has a bottom panel connected to two side panels and a front panel. A tuck strip is an extension of the bottom panel, and is used to secure the bottom panel to space between the seat back and the seat bottom. Additional straps and hooks are used to secure the storage system to the seat. The front panel overhangs the front edge of the seat. The front panel is a padded or reinforced panel which presses against the front of the seat edge in the event of an abrupt stopping of the vehicle. The force exerted against the front panel in response assists in maintaining the front panel in an upright position. The seat storage system is configurable to join two seat storage systems in a expanded configuration.

This application claims the benefit of U.S. provisional application 61/1452,834 filed Mar. 15, 2011.

### FIELD OF THE INVENTION

This invention relates to the field of storage solutions for automotive vehicles.

### BACKGROUND OF THE INVENTION

Various objects are often carried within a vehicle. Frequently, objects may be scattered throughout a vehicle due to movement and sudden stopping of the vehicle. Car seat organizers are available for containing various objects within a car. However, many car seat organizers restrict the user's options by having compartments of pre-determined sizes, which may not be able to hold all the objects as desired by the driver. The use of seat organizers having compartmentalized regions is also disadvantageous because the driver is required to put the item back into the compartment once the driver is done with the item. This can divert the driver's attention from the road. Other car seat organizers do not have the capacity to secure the organizer to a stationary object within the car, thus the entire organizer and its contents risk being spilled throughout the vehicle when a sudden stop is encountered. Current car seat organizers are also unable to adjust in size to meet the users desired size requirements, and can often be bulky and cumbersome to remove when space is needed to be cleared for passenger seating.

The present inventor has recognized the need for a car seat storage system which comfortably holds the user's loose items in the car.

The present inventor has recognized the need for a car seat storage system which is configurable to various sizes to adapt to the user's needs.

The present inventor has recognized the need for a car seat storage system which can easily allow passenger to sit on the eat on which the storage system is being used.

### SUMMARY OF THE INVENTION

A car seat storage system which provides an area of space for storage of loose items within a vehicle is provided. The car seat storage system is secured to the seat such that in the event of abrupt stops, the storage system, and its contents, remains in place on the car seat.

In one embodiment the car seat storage system comprises a bottom panel connected to two side panels and a front panel. The bottom, side, and front panels, together with the seat back of the seat the storage system is secured to, defines generally a region of space suitable for storing objects within a vehicle. The front panel overhangs the front edge of the seat such that the bottom portion of the front panel is in contact with front edge of the seat.

The bottom panel is attached to the side panels along seam lines. The bottom panel is attached to the front panel along a seam line. The front panel is removeably attached to the side panels.

Adjustable straps are used to connect the back end of the storage system to the seat back. Hooks connected to adjustable and removable straps are connected to the bottom portion of the front panel such that the bottom portion of the front panel can be secured to the underside of the seat.

In one embodiment, the storage system comprises a tuck strip connected to the bottom panel of the storage system such that when the tuck strip is tucked between the seat back and the seat, the bottom panel is secured to the seat and forward movement of the bottom panel and the panels associated therewith, is limited. The tuck strip can be used in lieu of, or in conjunction with, a strap for securing the lower back portion of the storage system.

In another embodiment, two side-by-side storage systems can be connected by removing the adjacent side panels from their respective front panels, and connecting the two front panels to form a continuous, longer front panel.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 illustrates a perspective view of an exemplary embodiment of the storage system.

FIG. 2 illustrates a side view of the exemplary embodiment of the storage system of FIG. 1.

FIG. 3 illustrates the storage system of FIG. 1 in a collapsed position, from a bottom view.

FIG. 4 illustrates the storage system of FIG. 1 in a collapsed position, from a top view.

FIG. 5 Illustrates one embodiment of the storage system connecting two storage system units to form a larger storage system.

FIG. 6 illustrates one embodiment of the storage system in use containing an object.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

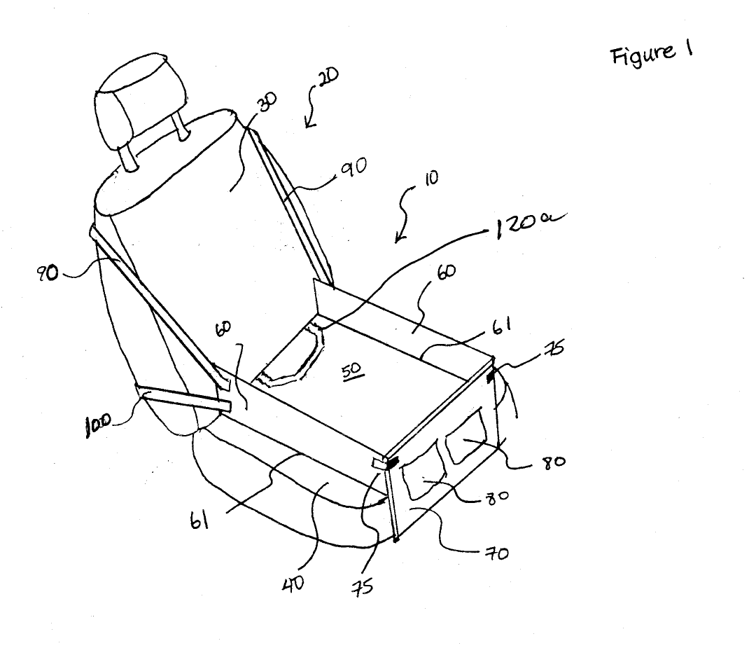

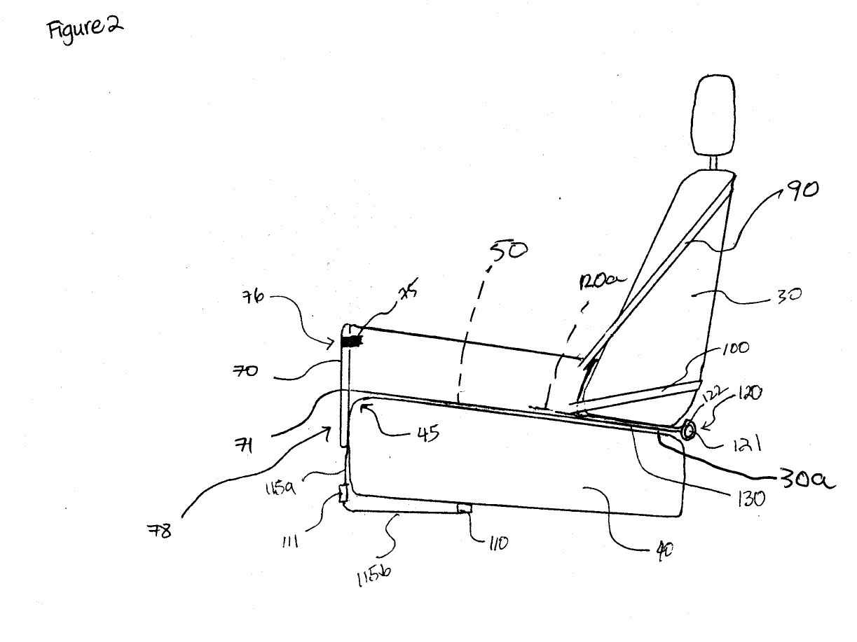

FIG. 1 illustrates an exemplary embodiment of the storage system. The storage system 10 is shown being used on car seat 20 with a seat back 30 and a seat bottom 40, typically characteristic of a front seat. The storage system 10 comprises a bottom panel 50 connected to two side panels 60 along a seam line 61. The front of the bottom panel 50 is connected to the front panel 70 along a seam line 71 (FIGS. 2-4). The front panel 70 is removeably connected to side panels 60 via an engagement mechanism 75. The front panel 70 can comprise storage pockets 80 as illustrated in FIG. 1.

The engagement mechanism 75 can be any engagement mechanism which allows the front panel to be releaseably attached to the side panels 60. The engagement mechanism can be, for example, the use of complementary VELCRO strips on the side panel 60 and on the front panel 70, or the use of a VELCRO strip 75a connected to the front panel 70, threaded through a buckle 76 on the side panel 60. Other engagement mechanisms such as snap buttons, clasps and the like, can also be used.

The bottom and side panels can be made of a flexible material to allow the user to accommodate various objects and their shapes. The flexible material can be fabric, made from synthetic or natural materials. Materials such as nylon or polyesters can be used. Flexible material such as rubber, or rubber like materials with elastic properties can also be used. Other materials, such as silicone or silicone-based materials, can be used to increase the friction between the storage system and the objects contained therein to decrease movement of the loose objects.

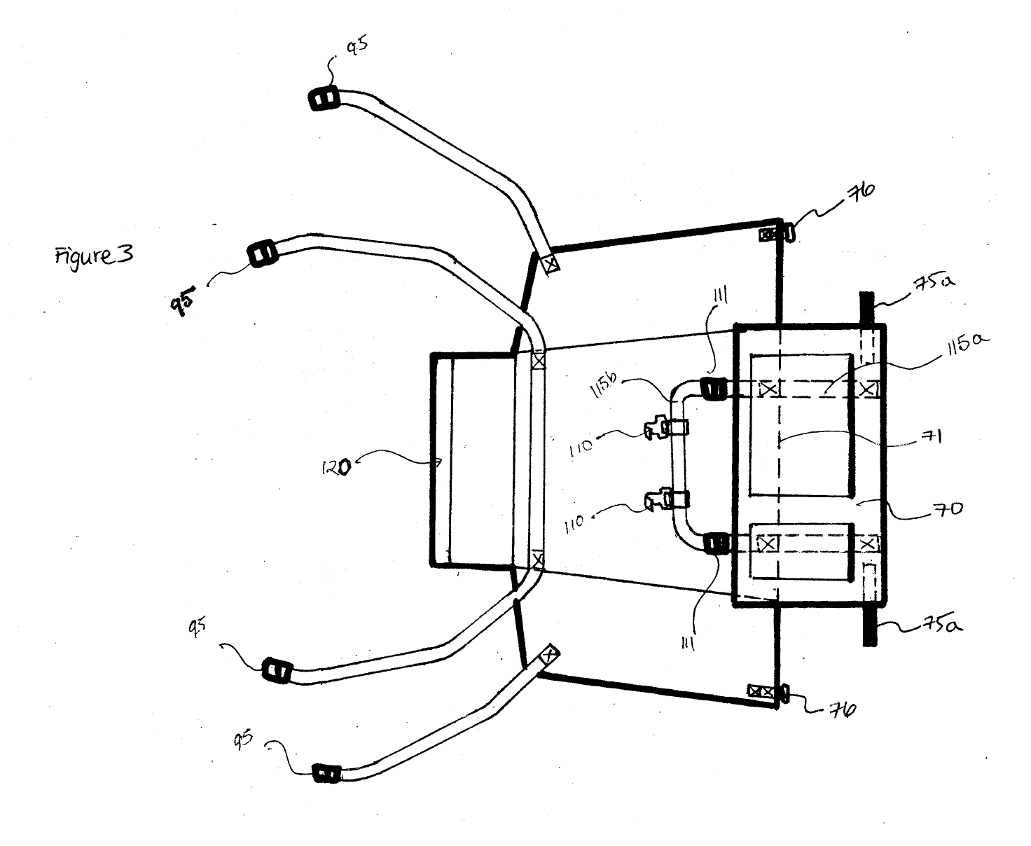

The storage system comprises several different mechanisms for securing the storage system to the seat of a vehicle. The storage system can comprise upper seat back straps 90 and lower seat back straps 100. Upper seat back straps 90 exert an upward force on the rearward portion of the side panels 60, while the lower seat back straps 100 exert a rearward force on the side panels 60. The upper and lower seat back straps are adjustable to suit various sizes of seat backs. Buckles, belts, clasps, VELCRO material, snap buttons, and other suitable mechanisms can be used to impart adjustablity to the straps. The straps can also be made of a resilient, elastic material such as rubber or spandex to allow the straps to adapt to various seat back sizes. Straps can be removeably attached to each other on their distal ends by complementary snap on buckle ends 95 (FIG. 3), VELCRO, snap buttons, and the like.

In one embodiment, a rearward force on the bottom panel 50 and on the side panels 60 is achieved using a tuck strip 120 (FIGS. 2-4), Tuck strip 120 is tucked between, and through, a gap 30a between the seat back 30 and seat bottom 40 as illustrated in FIG. 2, to exert a rearward force on the bottom panel 50. In the embodiment illustrated in FIG. 2, both the upper 90 and lower 100 seat back straps are in use, in conjunction with the tuck strip 120. In other embodiments, the tuck strip 120 can be used with just the upper seat back strap 90, In car seats where it is not feasible to tuck the tuck strip 120 between the seat back 30 and seat bottom 40, such as when a car seat cover is in use, the upper and lower seat back straps can be used.

The tuck strip 120 comprises a generally elongated or cylindrical body 121 disposed within a tubular region 122 of fabric or outer covering. The tuck strip 120 is on the distal end of a tuck panel 130 which is a rearward extension of the bottom panel 50. The tuck panel 130 remains between the seat back 30 and seat bottom 40. The elongated or cylindrical body 121 of the tuck strip can be made of a flexible, resilient material such that it can be compressed to be tucked between the seat back 30 and seat bottom 40, and conform to its original shape once on the other side of the seat back. The elongated or cylindrical body 121 should be of sufficient cross sectional size and of sufficient length to provide enough force to keep the bottom panel 50 in position, even in the event of a sudden stop.

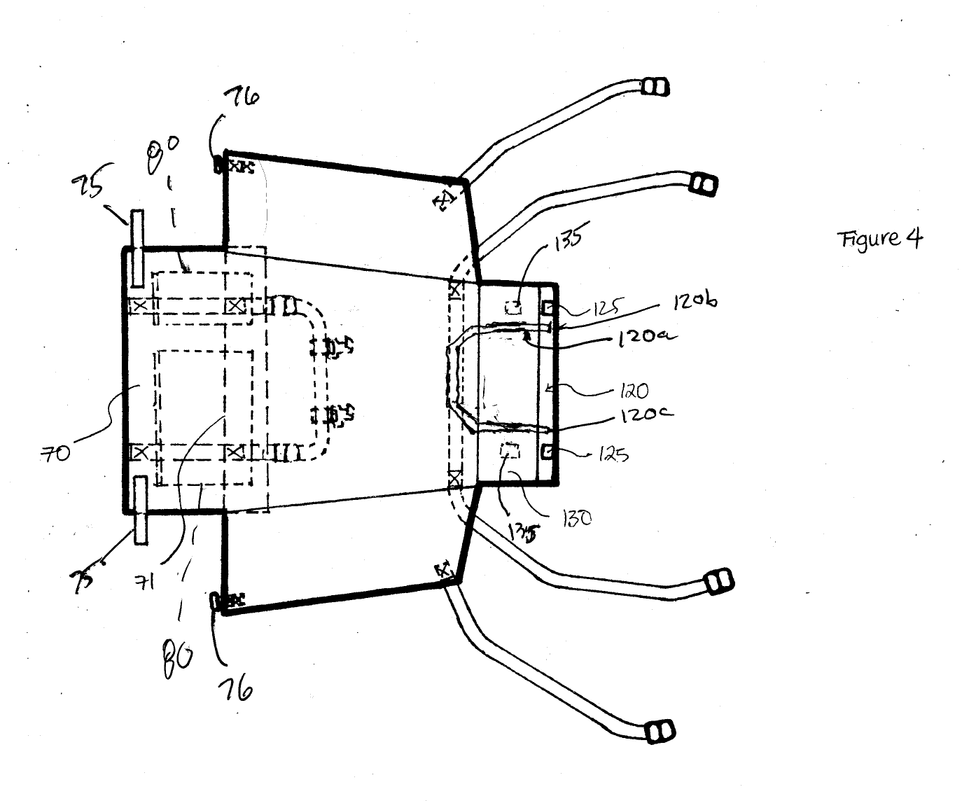

The tuck panel 130 is adjustable in length to accommodate for the different sizes in car seats. In vehicles where the seat back 30 is less thick, the tuck panel 130 may be too long, and much of the tuck panel 130 is slack on the back side of the seat back 30. To minimize the slack in the tuck panel 130, the tuck panel 130 can be rolled around the tuck strip 120. The portion of the tuck panel 130 taken up by the tuck strip 120 can be held in place by complementary sided VELCRO strips 135, 125 on the tuck panel 130 and tuck strip 120 respectively (FIG. 4). Other methods of keeping the tuck panel wrapped in place by the tuck strip 120 can also be used.

As shown in FIGS. 1 and 4, a removal strap 120a can be provided to make for easier removal of the storage system 10 when not in use. The strap 120a comprises a generally U-shaped strap, connected at ends 120b, 120c to the tuck strip 120 by stitching, fasteners, adhesive for other means. The removal strap 120a extends between the seat back 30 and seat bottom 40 on top of the bottom panel 50. The removal strap 120a is exposed on the front side of the car seat back 30 and allows a user to pull on the strap 120a to pull the tuck strip 120 back through the gap 30a between the seat back 30 and seat bottom 40 as a step to disengage and remove the storage system from the seat.

In one embodiment, at least one hook or a pair of hooks 110 (FIGS. 2-3) is used to provide stability to the front end of the storage system. Hooks 110 are located on first bottom strap portion 115b which is connected to second bottom strap portion 115a by removable engagement mechanisms 111. Removable engagement mechanisms 111 allow strap first bottom strap portion 115b and the hooks 110 to be disengaged from the second bottom strap portion 115a when a user does not desire the use of the hooks 110. Removable engagement mechanism 111 also allows the length of first bottom strap portion 115b (or alternately second bottom strap portion 115a) to be adjusted such that the hooks 110 can be located at the appropriate distance. The hooks 110 can be used to connect to any protruding ledge, frame, or structure underneath the seat. As illustrated, second bottom strap portion 115a is attached to the back of the front panel to minimize the forward movement of the front panel in the event of an abrupt stop.

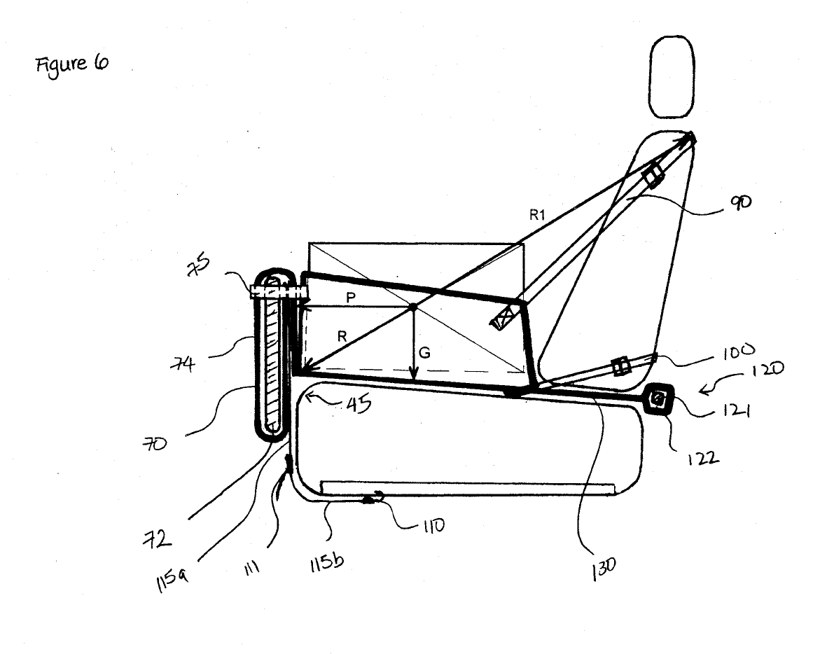

In one embodiment, the front panel 70 comprises a core panel 72 surrounded by the fabric 74 used for the bottom panel 50 and the side panels 60 (FIG. 6). The core panel 72 is made of a flexible, resilient material, and preferably exhibits shape memory characteristics. The core panel 72 is of sufficient rigidity to maintain an upright position. Materials suitable for the core panel 72 include polyurethane and polystyrene foams, rubber, and silicone. Other materials can also be used.

The front panel preferably exerts a sufficient rigidity such that when the contents press against the top portion 76 (FIG. 2) of the front panel 70, exerting a force as indicated by the arrow “P” in FIG. 6, the front panel 70 pivots generally about seamline 71 (FIG. 2) which generally corresponds to the edge 45 of the seat bottom 40. Without wishing to be bound by any particular theory, it is believed that when contents press against the top portion 76 of the front panel, the bottom portion 78 of the front panel presses against the seat bottom 40, causing the seat bottom 40 to exert a force in an opposing direction, which results in causing the top portion 76 of the front panel to move rearward, to keep contents of the storage system in place.

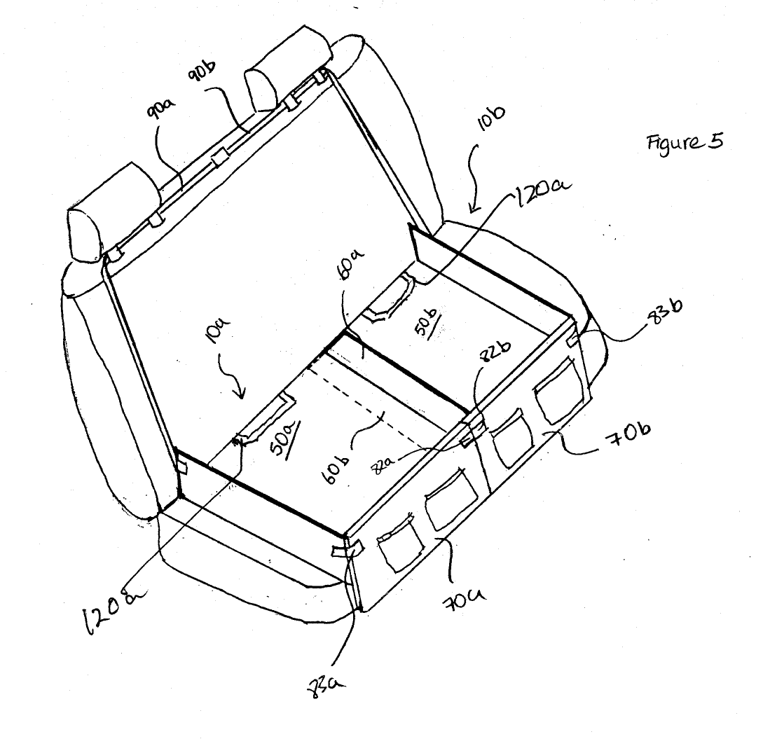

In another embodiment, the seat storage system can be configured to provide an expanded storage area. If a larger storage area is desired to carry loose objects in a vehicle, the larger space of the back seats can be used to support two adjacent storage systems as illustrated in FIG. 5. To connect two storage systems to provide an expanded storage area, two storage systems can be placed side-by-side, with adjacent side panels disconnected from the front panel and overlaid on a portion of the bottom panel of the adjacent storage system. As illustrated in FIG. 5, side panel 60a from storage system 10a is over laid over a portion of the bottom panel 50b. Side panel 60b (show in dashed lines) from storage system 10b is disposed underneath the bottom panel 50a of storage system 10a. By overlaying the side panel 60a over a portion of the adjacent storage system to act as a second layer over a portion of the bottom panel 50b, the bottom panels are continuous, and allows for an object to be placed within the area of space defined by the boundaries of two connected storage systems. To connect the front panels of the adjacent storage system together, engagement mechanisms 75 which are used to connect the side panels 60 to the front panel 70 (FIGS. 1 and 2), are disengaged from the adjacent side panels 60a, 60b in FIG. 5 to allow the panels 60a, 60b to lay flat along the back seat. The engagement mechanisms 82a, 82b on adjacent front panels 70a, 70b are connected with each other to join the front panels 70a, 70b together. Engagement mechanism 82a, 82b can be complementary parts which can join together by snap fitting such as a releasable clasp or buckle. Alternatively, engagement mechanism 82a and 83b can be complementary VELCRO strips. Depending on the type of engagement mechanism selected to join the side panels to the front panels, and the front panels to each other, engagement mechanisms on either side of the front panel 82a, 83a, and 82b,83b may be complementary to allow engagement mechanisms which are adjacent 82a, 82b in the expanded storage configuration to complementarily engage with each other.

In the expanded configuration, in one embodiment, the upper seat back straps 90a, 90b are joined together to secure the expanded storage system to the seat back. The straps can also be secured in other ways, such as around the back of the seat, depending on the configuration of the back seats. In the embodiment shown in FIG. 5, tuck strips (not visible.) are used to anchor the rearward portion of the bottom panel to the region between the seat back and seat bottom. Depending on the configuration of the back seats, a user may be able to use the lower seat back straps as well or in lieu of the tuck strips to secure the expanded storage system to the seats, or to provide more rigidity to the storage system.

In another embodiment, the side panels and/or the bottom panels can also be made with a core panel similar to the front panel to provide for a padded effect.

In use, the user places the storage system on the desired seat(s) and secures the storage system to the seat using the upper seat back straps with the tuck strip and/or with the lower seat back straps. If using the tuck strip, the user determines an appropriate length of the tuck panel for the thickness of the seat back, and scrolls any excess tuck panel material around the tuck strip, Alternatively, the tuck strip can remain in the region between the seat back and the seat bottom, and need not extend to exit on the back side of the seat. A user can secure the front panel by adjusting the straps connected to the hook to determine the appropriate length needed for the hooks to reach a support or a frame with which to engage.

If a passenger desires to sit in the seat being occupied by a storage system, the user can disconnect the side panels from the front panels and sit over the bottom panel of the storage system. This allows a user to easily change the seating area from being able to carry a passenger to being a storage area, without having to disassemble or remove the storage system from the seat.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A storage system for use within a vehicle, particularly on a vehicle car seat having a car seat back and a car seat bottom, comprising:
a bottom panel connected to two side panels and a front panel;
a tuck strip connected to a tuck panel extending rearward from the bottom panel, said tuck panel and said tuck strip configured to fit through the gap between the seat back and the seat bottom, with said tuck strip being positioned on a backside of said car seat back, said tuck strip preventing said tuck panel from pulling loose in a forward direction from a back side of said seat back.

2. The storage system according to claim 1, comprising at least a pair of adjustment straps for securing the storage system to the seat back.

3. The storage system according to claim wherein the bottom panel and two side panels are releasably connected.

4. The storage system according to claim 1, wherein said tuck strip is resiliently compressible to fit through said gap.

5. The storage system according to claim 1, comprising a removal strap connected to the tuck strip and positionable on a front side of the car seat back.

6. The storage system according to claim 1, wherein the front panel is configured to overhang the front edge of the car seat bottom.

7. The storage system according to claim 6, wherein the front panel s reinforced to prevent bending to press against the front edge of the seat bottom when installed and subjected to an inside force forward direction.

8. The storage system according to claim 1, wherein at least one side panel is releasably connected to the front panel in order to fold flat.

9. The storage system according to claim 1, wherein the side panels are composed of flexible material.

10. The storage system according to claim 9, wherein the front panel is composed of flexible material.

11. The storage system according to claim 1, comprising at least one bottom strap portion configured to connect the front panel to an underside of the car seat bottom.

12. The storage system according to claim 11, wherein the at least one bottom strap portion comprises hooks for removably engaging the storage system beneath the car seat bottom.

13. The storage system according to claim 12, wherein the at least one bottom strap portion comprises a first bottom strap portion having at least one hook, and a second bottom strap portion connected to the front panel, wherein the first and second bottom strap portions are connected together in a manner that the length of the first and second bottom strap proportion can have an adjustable length allowing the at least one hook to be adjusted in positioned beneath the car seat bottom.

14. The storage system according to claim 1, wherein the bottom, front and side panels can be disengaged from each other and all folded flat in a non-use storage configuration.

15. The storage system according to claim 1, wherein at least one of the front and side panels comprises pockets for storing articles.

16. The storage system according to claim 1, comprising straps attached to said side panels and configured to engage around the seat back to hold the side panels from sliding forward during vehicle stops.
